(19) United States
(12) Patent Application Publication
(10) Pub. No.: US 2024/0280501 A1
(43) Pub. Date: Aug. 22, 2024

(54) SYSTEMS, DEVICES, AND METHODS FOR DIAGNOSTICS MEASUREMENTS

(71) Applicants: UNIVERSITY OF WASHINGTON, Seattle, WA (US); UbiDX, Inc., Redmond, WA (US)

(72) Inventors: Paul Yager, Seattle, WA (US); Steven Bennett, Seattle, WA (US); Kamal Girish Shah, Seattle, WA (US); Katherine Sharadin, Seattle, WA (US)

(73) Assignees: UNIVERSITY OF WASHINGTON, Seattle, WA (US); UbiDX, Inc., Redmond, WA (US)

(21) Appl. No.: 18/567,512

(22) PCT Filed: Jun. 13, 2022
(86) PCT No.: PCT/US2022/033263

§ 371 Date: Dec. 6, 2023

Related U.S. Application Data
(60) Provisional application No. 63/210,449, filed on Jun. 14, 2021.

(51) Int. Cl. G01N 21/88; G01N 15/1434

(52) U.S. Cl. CPC G01N 21/8806; G01N 15/1434; G01N 2021/8816

(57) ABSTRACT

A base and a diagnostic system for analyzing a sample is described herein. In an embodiment, the system includes a cartridge and a base configured to couple with the cartridge. In an embodiment, the cartridge is configured to hold a sample, and comprises a transparent viewing field positioned in the detection zone. In an embodiment, the base includes a detection component including a window to allow a light from a detection zone of the cartridge to enter the base, and a photodetector positioned to receive the light through the window and configured to generate a signal based on the light received, a plurality of light sources that emit one or more illumination lights onto the detection zone, and a controller communicatively configured to illuminate the detection zone with the plurality of light sources, and generate a detection signal with the photodetector based on the light received.

### CROSS-REFERENCE TO RELATED APPLICATION

This application claims the benefit of U.S. Provisional Application No. 63/210,449 filed Jun. 14, 2021, the entire contents of which are hereby expressly incorporated by reference.

### SUMMARY

In one aspect, the present disclosure provides a base, such as for coupling to a cartridge for analyzing an analyte. In an embodiment, the base includes an anchoring component configured to secure a cartridge to the base, a detection component including a window positioned to allow a light from a detection zone of the cartridge to enter the base when the cartridge is coupled to the base, and a photodetector positioned to receive the light through the window and configured to generate a signal based on the light received from the window, a plurality of light sources configured to emit one or more illumination lights onto the detection zone through the window when the cartridge is coupled to the base, and a controller communicatively coupled to the photodetector and the plurality of light sources, the controller including logic that, when executed by the controller, causes the base to perform operations including illuminating the detection zone with the plurality of light sources, and generating a detection signal with the photodetector based on the light received by the photodetector is disclosed.

In another aspect, the present disclosure provides a system configured to analyze a sample. In an embodiment, the system includes a base including an anchoring component configured to secure the cartridge to the base, a detection component comprising, a window positioned to allow a light from a detection zone of the cartridge to enter the base when the cartridge is coupled to the base, a photodetector, positioned to receive the light through the window and configured to generate a signal based on the light received from the window, and an optical filter subcomponent positioned between the detection window and the photodetector to filter light received by the detection window, a plurality of light sources configured to emit one or more illumination lights onto the detection zone through the window when the cartridge is coupled to the base, and a controller communicatively coupled to the photodetector and the plurality of light sources of the controller including logic that, when executed by the controller, causes the base to preform operations, including illuminating the detection zone with the plurality of light sources; and generating the detection signal with the photodetector based on the signal light received by the photodetector, and a cartridge configured to hold a sample, comprising a transparent viewing field configured to be positioned in the detection zone when the cartridge is coupled to the base is disclosed.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the subject matter disclosed herein will become more readily appreciated as the same become better understood by reference to the following detailed description, when taken in conjunction with the accompanying drawings, wherein:

FIG. 1A is an example system, in accordance with the present technology;

FIG. 1B is an example cartridge, in accordance with the present technology;

FIG. 2A is an internal view of an example base, in accordance with the present technology;

FIG. 2B is an is an internal view of an example base coupled with a cartridge, in accordance with the present technology;

FIG. 3A is an example optical filter subcomponent, in accordance with the present technology;

FIG. 3B is an example cartridge, in accordance with the present technology;

FIG. 3C shows the optical filter subcomponent of FIG. 3A interacting with the example cartridge of FIG. 2B, in accordance with the present technology;

FIG. 4A is an internal view of an example base, in accordance with the present technology;

FIG. 4B is an internal view of the example base of FIG. 4A coupled with a cartridge, in accordance with the present technology; and

FIG. 5 is an example system including one or more other bases, in accordance with the present technology.

### DETAILED DESCRIPTION

Embodiments of a base and a diagnostic system for analyzing a sample is described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Described herein are systems and bases for making, for example, point-of-care measurements of a wide range of chemical, biochemical and physical states of a sample based on a reusable permanent base, and a series of compatible disposable cartridges that enable the performance of a wide range of tests on the system. As described further herein, by combining the base with different types of cartridges, bioanalytical and medical tests of different categories may be rapidly carried out by relatively untrained users in a non-laboratory environment. In an embodiment, these categories include nucleic acid amplification tests, lateral flow immunoassays, clinical chemistry tests, and physical measurements of such parameters as clotting times, aggregation of cells, to the extent that these assays can be quantified using optical imaging. In an embodiment, the system may be used for testing of acute and chronic disease states, and for medical testing outside of a laboratory, including in the home. Accordingly, in use the systems of the present disclosure are simple to operate with few user steps, and there exists an ability to self-test and validate results before their transmission. Additionally, the system disclosed herein provides a lower risk of sample contamination and contamination of personnel by the sample and testing processes. In an embodiment, the system can also be used for a wide range of non-medical testing, including from environmental monitoring, plant and animal health, and food safety.

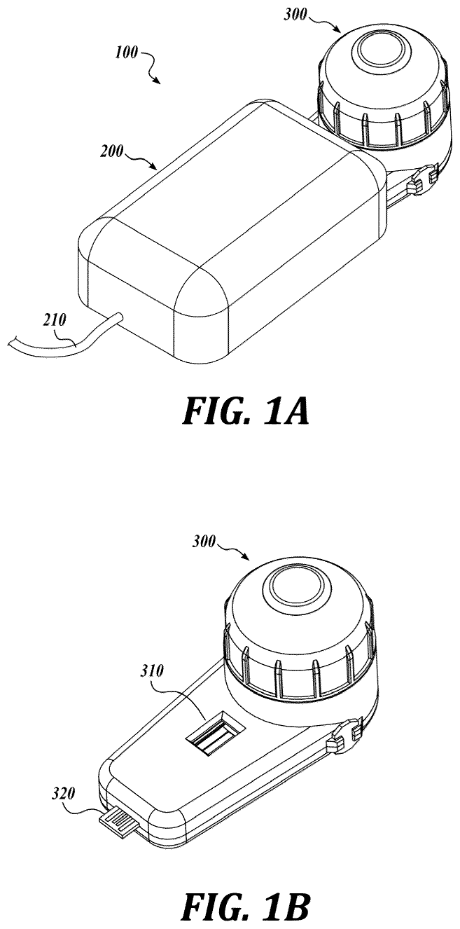

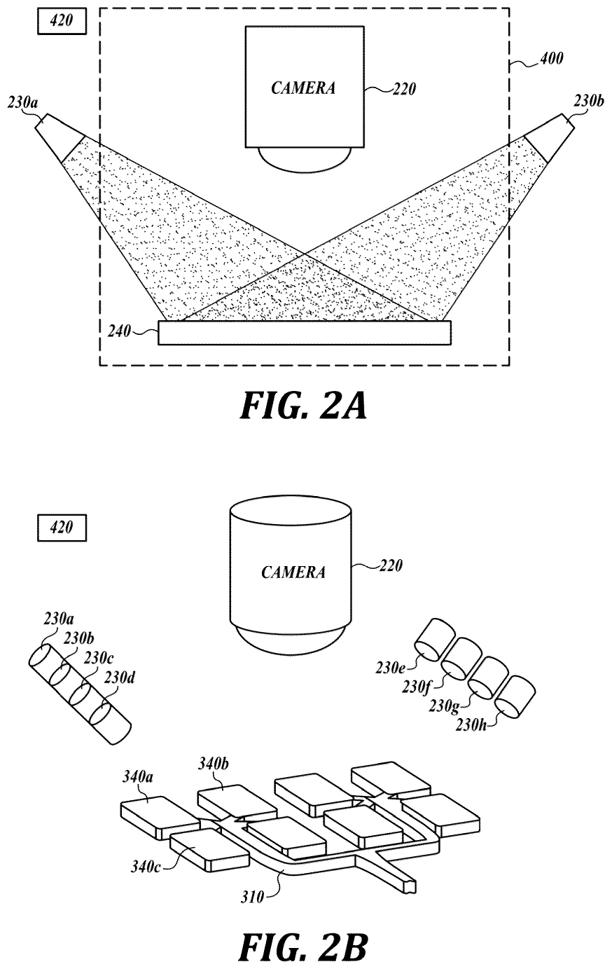

As above, in an aspect, the present disclosure provides for diagnostic system 100 for analyzing a sample. In that regard, attention is now directed to FIGS. 1A and 1B, in which a system 100 according to an embodiment of the present disclosure, is illustrated. The system 100 is configured to analyze a sample. The system 100 is shown to include a base 200 and a cartridge 300. In some embodiments, the base 200 includes a power source 210. While the power source 210 is illustrated as a wired connection, the power source 210 may be fully contained within the base 200, such as a battery, a capacitor, or the like. The base 200 may also be powered with a wireless connection. The base 200 is reusable such as with multiple cartridges, and may include various components, as described in detail herein. In some embodiments, the base 200 and the cartridge 300 are configured to couple with one another to form the system 100 for performing at least one test on a sample inside the cartridge 300. In some embodiments, the base 200 and the cartridge 300 are configured to form a light-tight seal when the cartridge 300 is received by the base 200. In some embodiments, the base 200 is opaque, with the exception of the portion configured to accept the cartridge 300, so as to shield a detection component (as illustrated in FIG. 2A) and various internal components of the base 200 and the cartridge 300 from external light so as to enable, among other tests, fluorescence and chemiluminescence experiments to be carried out within it. Such a configuration allows optical experiments to proceed even when the base 200 is in full sunlight. In some embodiments, the base 200 and the cartridge 300 are configured to form a light-tight seal, such that the internal components of the base 200 and the cartridge 300 are shielded from external light through the connection between the base 200 and the cartridge 300.

In operation, the cartridge 300 is coupled to the base 200 to form a light-tight seal. The light-tight seal may be configured to further shield the internal components of the base 200 and the cartridge 300 from external light where the base 200 and the cartridge are coupled. In some embodiments, the cartridge 300 is disposable. The cartridge 300 may be swapped out with another cartridge. Any number of cartridges 300 could be coupled to the base 200. Once the cartridge 300 and the base 200 are coupled into the system 100, the base 200 and the cartridge 300 are configured to perform one or more tests as described herein.

FIG. 1B is an example cartridge 300, in accordance with the present technology. As shown, the cartridge 300 includes a detection zone 310, and an identifier 320. In some embodiments, the cartridge 300 is shaped in a way to couple with a base 200, such as the base 200 illustrated in FIG. 1A. In some embodiments, the cartridge 300, with the exception of the detection zone 310, is completely opaque and light tight. As described herein, the cartridge may be disposable.

In some embodiments, the detection zone 310 is configured to allow light from the detection component of the base 200, as described in FIGS. 2A and 2B, when the cartridge 300 is coupled to the base 200. In some embodiments, the detection zone 310 exposes internal reagents, samples, and/or components of the cartridge 300 to light, such as light emitted from the base 200.

In some embodiments, the cartridge 300 further includes an identifier 320. The identifier 320 is chosen from a chip, a QR code, a barcode, and the like. In some embodiments, the identifier 320 is configured to generate or provide information for receipt by the base 200 based upon an identity of the cartridge 300 and reagents disposed therein. In some embodiments, the information may include the nature or type of a test to be carried out, any specific steps for performing the test as determined by a manufacturer, whether the test was conducted recently enough to be able to ensure trust in the results, and specific steps for performing the particular test based on a lot number (for example, environmental requirements). In some embodiments, the controller 420 of the base 200 (as illustrated FIG. 2A) may acquire timed data from the cartridge 300, potentially including but not limited to: temperature of specific regions of the cartridge 300, current or voltages applied to the cartridge 300 and/or measured on the cartridge 300, images of the detection zone 310 (either single static images, an image stack over a period of time, or a video over a period of time), and/or images of the cartridge 300 to facilitate quality control and/or quality assurance.

In operation, the base 200 is configured to read the identifier 320, such as by generating one or more signals based on the identifier 320, when the cartridge 300 is coupled to the base 200. The identifier 320 may then provide the base 200 with the age of the sample, the type of test to be performed, and the type of cartridge 300 inserted, among other information as described herein.

In some embodiments, the cartridge 300 is shaped to receive a sample. In some embodiments, the sample may be one or more fluids. In some embodiments, the cartridge 300 contains reagents used in performing one or more tests on the sample. Example tests include determining the chemistry of one or more components in the sample, the content of the sample, the state of aggregation of particles in the sample, and the volume of the sample. Further, the tests may include nucleic acid amplification reactions, such as isothermal, multi-thermal, or cyclical reactions detected in real time or at the end of a fixed period. The tests may also include lateral flow detection of proteins and small molecules using optically absorbent labels, such as gold particles or colored microspheres, fluorescent and phosphorescent labels such as small molecule fluorophores, quantum dots, and phosphors, or enzyme labeled binders that produce soluble colored products, colored precipitates, fluorescent soluble molecules, or fluorescent or luminescent precipitates, such as the horseradish peroxidase (HRP) and 3, 3-diaminobenzidine (DAB) system, and EASE. In some embodiments, the cartridge 300 is also configured for testing colorimetric or light scattering changes in one or more regions of the detection zone 310 to detect aggregation or viscosity of a sample of complex fluids. For example, the cartridge 300 is configured to generate of signal based on aggregation of blood cells (induced or pre-existing), clotting time, etc. In some embodiments, the cartridge 300 contains reagents needed for the one or more tests and is capable of being stored for one year, at room temperature, without refrigeration. Further, the cartridge 300 is configured to prevent the sample from being released into the base 200 and/or the environment during and after the processing of the sample. In this way, the cartridge 300 is configured to prevent contamination.

In some embodiments, the cartridge 300 further includes fluidic components configured to collect the sample, process the sample, and/or move the sample through the cartridge 300 to facilitate one or more tests. In some embodiments, the fluidic (or microfluidic) components include electrically actuated valves microporous microfluidic elements. In some embodiments, the fluidic components include actuated valves and microporous elements. In some embodiments, operation of the fluidic components is directed or choreographed with a processor or microprocessor located inside the cartridge 300 or the base 200. Further, the cartridge 300 may also allow for a portion of the sample to be retained for subsequent analysis. Such analysis may include but is not limited to sequencing of pathogens on return of the cartridge 300 to a vendor.

In some embodiments, the cartridge 300 may further include one or more heaters and one or more thermal sensors configured to control and time heating of regions (such as regions 340a, 340b, and 340c of FIG. 2B) of the cartridge 300 under control of the controller 420 in the base 200 to allow such functions as sample lysis, amplification of nucleic acids, performing assays under controlled conditions, and opening or closing of valves

FIG. 2A is an internal view of an example base 200, in accordance with and embodiment of the present technology. In some embodiments, the base 200 includes a detection component 400, a controller 420, and a plurality of light sources 230a, 230b. In an embodiment, the base 200 is an example of base 200 discussed further herein with respect to FIGS. 1A and 1B.

The detection component 400 may include a photodetector 220, and a window 240. In some embodiments, the window 240 is positioned to allow a light from a detection zone of the cartridge 300 (such as detection zone 310 in FIG. 1A) to enter the base 200 when a cartridge 300 is coupled to the base 200. In some embodiments, the photodetector 220 is positioned to receive the light through the window 240 and generate a signal in response to the received light. In some embodiments, such as that illustrated in FIG. 2A, the photodetector 220 is a camera, but in other embodiments, the photodetector 220 may take the form of any photodetector capable of detecting light, such as one or more photodiodes, an avalanche photodiode, a phototransistor, a diode array, a flat-bed scanner, a laser scanner with a single detector, or any other optoelectronic.

In some embodiments, the base 200 further includes a plurality of light sources 230a and 230b. In some embodiments, the plurality of light sources 230a and 230b are configured to emit one or more illumination lights through the window 240 and into a detection zone (as shown in FIG. 2B). In some embodiments, the window 240 defines a plane, and the plurality of light sources 230a and 230b emit the one or more illumination lights at a non-normal angle to the plane, as shown in FIGS. 2A and 2B. Angling the illumination may avoid specular reflections while covering the entire window 240, and therefore the entire detection zone 310. The plurality of light sources 230a and 230b may be configured to emit any type of light, including white light, colored light in any number of colors, UV light, fluorescent light, infrared (IR) light, or near infrared light (NIR). In some embodiments, the light sources 230a and 230b may be configured to deliver more than one type of light, simultaneously or concurrently.

In some embodiments, the base 200 further includes mechanisms for ensuring that the entire detection zone 310 of the cartridge 300 is sufficiently uniformly and properly illuminated. In some embodiments, the light sources 230a and 230b are photon-emitting devices, such as LEDs. In some embodiments, the light sources 230a and 230b include an optical filter, so that the illumination light is colored, or has a particular quality, such as fluorescence. In some embodiments, the photodetector 220 is configured to take images of the detection zone 310 and normalize the images as if they had been uniformly illuminated. In some embodiments, multiple regions (such as regions 340a, 340b, and 340c of FIG. 2B) of one or more colored or fluorescent or luminescent materials (as appropriate for the nature of the test) are located in the detection zone 310 and configured to illuminate the detection zone 310 and emit a measured intensity. The photodetector 220 may be configured to observe the measured intensities of these regions and mathematically normalize the illumination and detection efficiency across the detection area in subsequent image processing prior to the controller reading test results.

In some embodiments, the base 200 further includes a controller 420. The controller 420 may be operatively coupled to the photodetector 220. In an embodiment, the controller 420 is operatively coupled to and configured to exchange signals with a cloud-based computing platform. The controller 420, the cloud-based platform, or both, may perform quantitative, semiquantitative, or qualitative capture of images of the detection zone with the photodetector 220, in a series of images collected over the lifetime of the assay, adaptive light intensity measurements by tracking all of or a subset of the detection (or amplification) zone, e.g., the most rapidly changing intensities across the amplification zones, analysis of the images in such a way as to provide qualitative or quantitative information from the test, transmission of the raw or processed data or metadata to the provider of the system to allow for evaluation of the performance of said system for continue quality improvement, test validation and determination of if the base 200 and cartridges 300 are in working order, transmission of test results to the tester and the provider of the system, and control of all test functions through the base 200, including heating, timing, and providing feedback to the tester as to proper insertion of the cartridge 300, the current status of the base 200, and when the test is complete.

In operation, controller 420 directs the plurality of light sources 230a and 230b to illuminate the detection zone 310 of the cartridge 300 (as shown in FIG. 2B) through the window 240. The controller 420 is configured to direct the photodetector 220 to generate a signal based on the light received from the window 240. In some embodiments, the controller 420 directs the base 200 to generate a detection result based, in part, on the received signal. The base 200 may generate the signal based on an intensity of light received from the window 240. The intensity of light is then be communicated to the controller 420. In some embodiments, the photodetector 220 is configured to perform adaptive intensity measurements by tracking the most rapidly changing intensities across the detection zone 310. The controller 420 may also be capable of processing image data from the photodetector 220 to generate a detection result, such a positive or negative test result. The controller may also detect device failures based on unwanted or unexpected changes in the light intensity in and around the detection zone 310. For example, the controller 420 may detect a failure of fluid reagents or samples to reach one or more control regions of the detection zone 310.

Additionally, the controller 420 may control the timing of various actions of the base 200, such as the illumination of the detection zone, the capturing of light by the photodetector, and the generation of the detection result, validate that steps needed to be performed prior to running the test have been properly performed (e.g., the cartridge 300 has been closed to prevent leakage, evaporation, etc.), validate that the steps needed to be performed while running the test have been properly performed (e.g., valves are in desired state, sufficient fluid or hydration levels are maintained), provide power to elements on the cartridge 300 of sufficient quantity and duration to perform various functions needed to complete the test(s), engage in feedback control of elements of the cartridge 300 to attain and maintain functions (such as heating a portion of a cartridge 300 to a target temperature beginning at a specific time and for a specified duration), and change the control of elements in the cartridge 300 as determined by data acquired by the controller 420, store data for extended periods with or without external power results from said data, or to upload it to a remote site for processing transmit the detection result of the test and/or metadata to the local users(s) and remote personnel and systems as needed by the user and others.

FIG. 2B is an is an internal view of an example base 200 coupled with a cartridge 300, in accordance with the present technology. In some embodiments, the base 200 includes a photodetector 220, and a plurality of light sources 230a, 230b, 230c, 230d, 230e, 230f, 230g, and 230h. While not illustrated for clarity, it should be understood that the base further includes a window (such as window 240 in FIG. 2A) disposed between the photodetector 220 and a detection zone 310 of a cartridge 300. In some embodiments, the detection zone 310 of the cartridge 300 includes a plurality of regions 340a, 340b, 340c . . . 340n.

In some embodiments, the plurality of light sources 230a, 230b, 230c, 230d, 230e, 230f, 230g, and 230h are located on two sides of the detection zone 310, such as illustrated in FIG. 2B. In some embodiments, the plurality of light sources 230a, 230b, 230c, 230d, 230e, 230f, 230g, and 230h are arranged in another form configured to illuminate the detection zone 310, such as a ring or border surrounding the detection zone 310. While eight light sources 230a, 230b, 230c, 230d, 230e, 230f, 230g, and 230h are illustrated, any number of light sources 230 may be incorporated into the base 200. In some embodiments, the plurality of light sources 230a, 230b, 230c, 230d, 230e, 230f, 230g, and 230h are each configured to deliver a different kind of light, such as white light, colored light in any number of colors, UV light (such as UVA and UVB light), fluorescent light, IR light, or NIR light. In some embodiments, the different kind of light is of different wavelength ranges. In some embodiments, the wavelength ranges include of 400-700 nm (visible light), 280-315 nm (UVA light), 315-400 nm (UVB light), and >700 nm (IR light). In some embodiments, light may be fluorescent light having a frequency between 10 KHz and 100 MHz. A light source 230a may be configured to emit light at a first wavelength, while a second light source 230b may be configured to emit light at a second wavelength, different from the first wavelength. In some embodiments, the plurality of light sources on the first side 230a, 230b, 230c, and 230d are configured to emit a number of different kinds of light, and the plurality of light sources 230e, 230f, 230g, and 230h on the second side emit the same number of kinds of light, so that one light source 230a and 230e on each side is configured to emit the same kind of light. In some embodiments, the light sources 230a, 230b, 230c, 230d, 230e, 230f, 230g, and 230h of the plurality of light sources 230a, 230b, 230c, 230d, 230e, 230f, 230g, and 230h are positioned so that each type of light illuminates an appropriate region (for example 340a) of the plurality of regions 340a, 340b, and 340c in the detection zone 310.

In some embodiments, each region 340a, 340b, and 340c may represent an illumination element. For example, regions 340a, 340b, and 340c may all be fluorescent material to help illuminate a fluorescence-based test. In some embodiments, regions 340a, 340b, and 340c may be components of a test. For example, 340a may be a colorimetric test to determine the presence of chemical, and 340b may be a control region. In some embodiments, the regions 340a, 340b, and 340c may be combination of test components and illumination materials.

In operation, the plurality of light sources 230a, 230b, 230c, 230d, 230e, 230f, 230g, and 230h illuminates the detection zone 310. In some embodiments, the plurality of light sources 230a, 230b, 230c, 230d, 230e, 230f, 230g, and 230h illuminate the plurality of regions 340a, 340b, 340c. In some embodiments, the plurality of regions 340a, 340b, and 340c, are illuminated simultaneously. In some embodiments, the regions 340a, 340b, and 340c are illuminated one at a time or in groups. For example, light source 230a may be configured to emit fluorescent light onto region 340a, but not the other regions 340b,340c . . . 340n. In this manner, the photodetector 220 is configured to then receive the light from the detection zone 310, and more specifically, the light from region 340a to generate a detection result for region 340a.

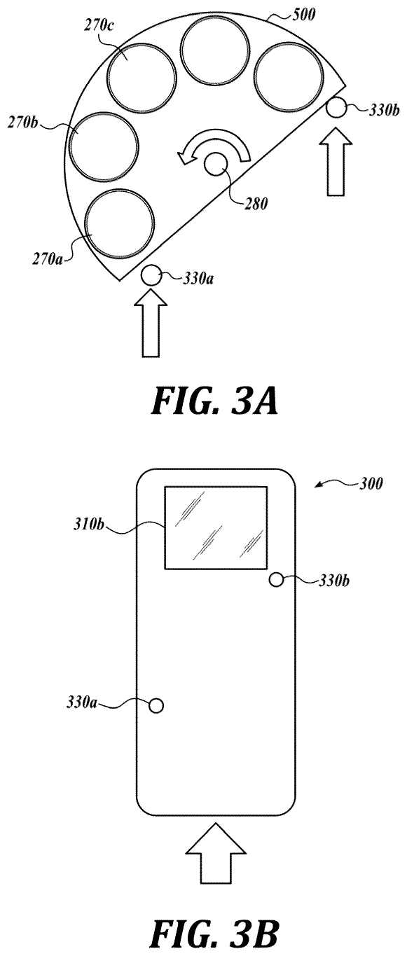

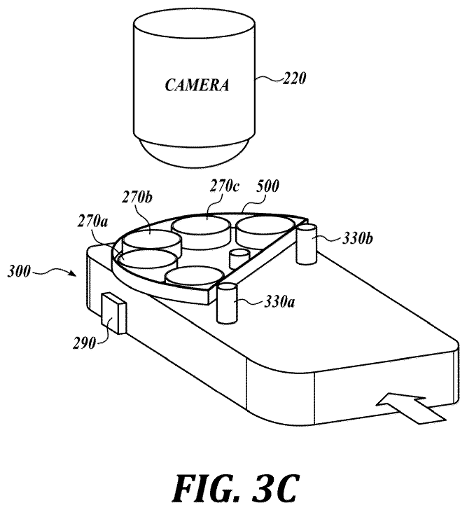

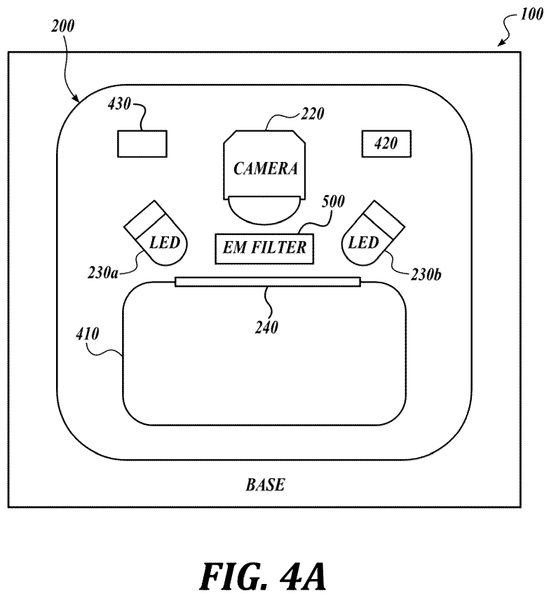

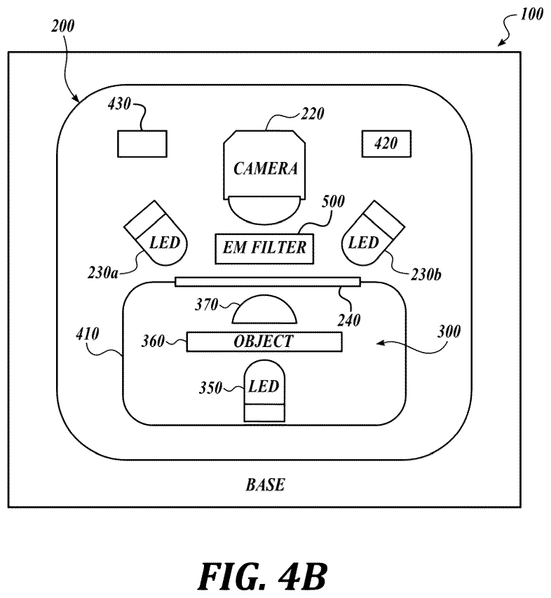

In an embodiment, the system 100 includes an optical filter subcomponent, such as a moveable frame, disposed, for example, in a base 200 of the system 100. In that regard, attention is directed to FIG. 3A in which an example optical filter subcomponent 500, in accordance with the present technology, is illustrated. The optical filter subcomponent 500 may take any number of forms, including a single optical filter (such as optical filter subcomponent 500 in FIGS. 4A-4B). The movable frame 500 is shown include a plurality of optical filters 270a, 270b, and 270c and a central post 280. While a moveable frame and posts are described, it will be understood that other optical filter subcomponents configured to position an optical filter between the detection zone 310 and the photodetector 220 are within the scope of the present disclosure.

In an embodiment, the optical filter subcomponent 500 is configured to position an optical filter 270 of the plurality of optical filters 270a, 270b, and 270c between the detection zone 310 and the photodetector 220 so that the one or more illumination lights emitted from the plurality of light sources passes through the optical filter 270 before reaching the detection zone 310 and/or one or more regions of the detection zone, as shown in FIG. 3C. The optical filters 270a, 270b, and 270c are configured to allow the passage of different ranges of wavelengths of light. For example, a first optical filter 270a is configured to pass a first wavelength of light, while a second optical filter 370b is configured to pass a second wavelength of light, distinct from the first wavelength of light. The optical filters 270a, 270b, and 270c are configured to filter an appropriate light for different assays. For example, the optical filters 270a, 270b, and 270c are configured to emit an appropriate light for detecting different detection reagents emitting light of different wavelengths. One or more pins 330a and 330b on the cartridge 300 may contact the optical filter subcomponent 500 when the cartridge 300 is inserted and move the optical filter subcomponent 500 so that the correct optical filter 270 of the plurality of optical filters 270a, 270b, and 270c is placed between the photodetector 220 and the detection zone 310.

In operation, when a cartridge 300 is inserted into the base 200, one or more pins 330a and 330b contact the optical filter subcomponent 500 so that the optical filter subcomponent 500 is rotated about the central post 280, so that an appropriate optical filter 270 of the plurality of optical filters 270a, 270b, and 270c is positioned between the photodetector 220 and the detection zone 310. Further, in some embodiments, the optical filter subcomponent 500 may be moved via instructions provided by the controller 420, or with instructions provided by the identifier 320 on the cartridge 300, as opposed to or in combination with pins 330a and 330b on the cartridge 300.

FIG. 3B is an example cartridge 300 with one or more pins 330a and 330b, in accordance with the present technology. In some embodiments, the cartridge 300 includes two pins 330a and 330b. In some embodiments, the cartridge 300 includes only a single pin 330. Further, in some embodiments, the cartridge 300 does not include any pins 330, and may instead provide instruction to the controller 420 of the base 200 with an identifier (such as identifier 320 of FIG. 1B).

In operation, the cartridge 300 is inserted into the base 200 in the direction indicated by the arrow in FIG. 3B. The first pin 330a may contact a first side of the optical filter subcomponent 500, while the second pin 330b may contact a second side of the optical filter subcomponent. In this way, the optical filter subcomponent 500 may be secured so that a particular optical filter 270 of the plurality of optical filters 270a, 270b, and 270c is positioned over the detection zone. The optical filter 270a may pass light of a first wavelength range. In some embodiments, a second cartridge (not shown), including two or more other pins positioned differently from the two or more pins, is configured to be inserted after removing the cartridge 300. When the two or more other pins contact the movable frame 500, a second optical filter 270 of the plurality of optical filters 270a, 270b, and 270c is positioned between the detection zone 310 and the photodetector 220. In some embodiments, the second optical filter 270b is configured to pass light of a second wavelength range, distinct from the first wavelength of the first optical filter 270a. In some embodiments, the one or more pins 330a and 330b may position the optical filter subcomponent 500 so that more than one optical filter 270a, 270b, and 270c of the plurality of optical filters 270a, 270b, and 270c is positioned above the detection zone 310.

FIG. 3C shows the optical filter subcomponent 500 of FIG. 3A interacting with the example cartridge 300 of FIG. 2B, in accordance with the present technology. In some embodiments, the base 200 further includes an anchoring component 290 to secure the cartridge 300 in the base 200. In some embodiments, the anchoring component 290 holds the cartridge 300 in place, and may take any form, such as a magnet or post.

In operation, the cartridge 300 is inserted into the base 200 in the direction of the arrow. The anchoring component 290 secures the cartridge 300 so that the detection zone 310 is lined up with the photodetector 220. The first pin 330a may contact the optical filter subcomponent 500 so that the optical filter subcomponent 500 rotates about the central post 280, before being stopped by the second pin 330b. The one or more pins 330a and 330b ensure that an optical filter 270 from the plurality of optical filters 270a, 270b, and 270c is positioned between the detection zone 310 of the cartridge 300, and the photodetector 220.

FIG. 4A is an internal view of an example base 200, in accordance with the present technology. In some embodiments, a base 200 includes an anchoring component (such as anchoring component 290) to secure a cartridge 300 to the base 200, a detection component (as shown in FIG. 2A) including a window 240 positioned to allow a light from a detection zone 310 of the cartridge 300 to enter the base 200 when the cartridge 300 is coupled to the base 200, and a photodetector 220 positioned to receive the light through the window 240 and configured to generate a signal based on the light received from the window 240, a plurality of light sources 230a, 230b configured to emit one or more illumination lights onto the detection zone 310 through the window 240 when the cartridge 300 is coupled to the base 200, and a controller 420 communicatively coupled to the photodetector 220 and the plurality of light sources 230a, 230b, the controller 420 including logic that, when executed by the controller 420, causes the base 200 to perform operations including illuminating the detection zone 310 with the plurality of light sources 230a and 230b, and generating a detection signal with the photodetector 220 based on the light received by the photodetector 220.

The controller 420 may further include logic that, when executed by the controller 420, causes the base 200 to perform operations including generating a detection result based, at least in part, on the signal. In some embodiments, the controller 420 is operatively coupled to the optical filter subcomponent 500, the photodetector 220, and the plurality of light sources 230a and 230b. The controller 420 may include logic that, when executed by the controller 420, causes the base 200 to perform operations including positioning an optical filter (such as optical filter 270) of the optical filter subcomponent 500 between the photodetector 220 and the window 240, analyzing the signal with the controller 420, generating a detection result, and outputting the detection result.

In some embodiments, the base 200 includes a docking port 410 configured to receive the cartridge 300. In some embodiments, the base 200 may further include an optical filter subcomponent 500 positioned between the window 240 and the photodetector 220 to filter light received through the window 240. As illustrated, the optical filter subcomponent 500 may be a single optical filter, such as an electromagnetic (EM) filter, but the optical filter subcomponent 500 may be any kind of filter, such as a polarizing filter, a colored filter, a fluorescent filter, an IR filter, an NIR filter, or the like. In some embodiments, the optical filter subcomponent 500 may be a movable frame (such as illustrated in FIGS. 3A-3C). In some embodiments, the window 240 defines a plane, and the plurality of light sources 230a and 230b are configured to emit one or more illumination lights at a non-normal angle to the plane.

FIG. 4B is an internal view of the example base 200 of FIG. 4A coupled with a cartridge 300, in accordance with the present technology. In some embodiments, a system 100 is configured to analyze a sample 360. As shown, the system 100 includes a base 200 including a detection component (such as detection component 400) including a window 240 positioned to allow a light from a detection zone 310 of the cartridge 300 to enter the base 200 when the cartridge 300 is coupled to the base 200, a photodetector (or camera) 220, positioned to receive the light through the window 240 and configured to generate a signal based on the light received from the window 240, and an optical filter subcomponent 500 positioned between the window 240 and the camera 220 to filter light received by the window 240, a plurality of light sources 230a and 230b to emit one or more illumination lights onto the detection zone 310 through the window 240 when the cartridge 300 is coupled to the base 200, and a controller communicatively 420 coupled to the photodetector 220 and the plurality of light sources 230a and 230b of the controller 420 including logic that, when executed by the controller 420, causes the base 200 to preform operations, including illuminating the detection zone 310 with the plurality of light sources 230a and 230b, and generating the detection signal with the camera 220 based on the signal light received by the photodetector 220, and a cartridge 300 configured to hold a sample (object) 360, including a transparent viewing field configured to be positioned in the detection zone 310 when the cartridge 300 is coupled to the base 200.

In some embodiments, the base 200 further includes a contactless reader 420 for reading an identifier on the cartridge 300, such as identifier 320. In some embodiments, the base 200 is configured to connect to one or more other cartridges 300 in addition to the cartridge 300. The cartridge 300 may be removed, and another cartridge (not shown) may be inserted. In some embodiments, the base 200 is configured to conduct tests on any number of samples contained within any number of cartridges 300. In some embodiments, the contactless reader 430 is further configured to generate an identity signal based on the identifier 320, wherein the contactless reader 430 is operatively coupled to the controller 420, the controller 420 including logic that, when executed by the controller 420, causes the base 200 to perform operations based on the identity signal. In some embodiments, the identity signal generated is a filter identity signal, and the controller 420 includes logic that when executed by the controller 420, causes the base 200 to position an optical filter 270 of the plurality of optical filters 270a, 270b, and 270c in the detection zone 310 based on the filter identity signal.

The cartridge 300 may include an object 360. In some embodiments, the object 360 may be a sample and any reagents used to facilitate testing of the sample as described herein. In some embodiments, the cartridge 300 may further include one or more cartridge LEDs (or light sources) 350, and one or more magnifying lenses 370 to further help visualize the object 670.

In operation, the cartridge LED 350 illuminates the object 360. The magnifying lens 370 magnifies the object through the window 240 so that the photodetector 220 may visualize the light received from the detection zone 310. In some embodiments, the controller 420 positions an optical filter subcomponent 500 between the photodetector 220 and the detection zone 310. The plurality of light sources 230a and 230b may illuminate the detection window 310. As a signal light is received by the photodetector 220 and send to the controller 420, the controller 420 analyzes the signal, generates the detection result, and outputs the detection result.

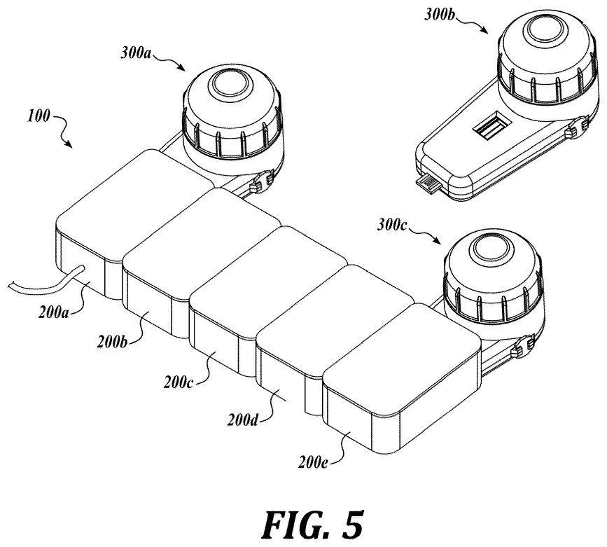

FIG. 5 is a perspective view of a system 100 including one or more bases 200a, 200b, 200c, 200d, and 200e, in accordance with the present technology. In some embodiments, the base 200a is coupled to one or more other bases 200b, 200c, 220d, and 200e. While five bases 200a, 200b, 200c, 200d, and 200e are shown coupled to one another, it should be understood that any number of bases 200 may be configured to be attached to one another. Accordingly, multiple cartridges 300a, 300b, 300c can be tested at the same time. As illustrated, only some of the bases (such as 200a and 200e) are coupled to a cartridge 300a, 300c at the same time. A user can use the plurality of bases 200a, 200b, 200c, 200d, and 200e as needed to test any number of samples contained in any number of cartridges 300a, 300b, and 300c.

The order in which some or all of the method steps appear or are described should not be deemed limiting. Rather, one of ordinary skill in the art having the benefit of the present disclosure will understand that some of the method steps may be executed in a variety of orders not illustrated, or even in parallel.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The complete disclosure of all patents, patent applications, and publications, and electronically available material (including, for instance, nucleotide sequence submissions in, e.g., GenBank and RefSeq, and amino acid sequence submissions in, e.g., SwissProt, PIR, PRF, PDB, and translations from annotated coding regions in GenBank and RefSeq) cited herein are incorporated by reference in their entirety. Supplementary materials referenced in publications (such as supplementary tables, supplementary figures, supplementary materials and methods, and/or supplementary experimental data) are likewise incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

All of the references cited herein are incorporated by reference. Aspects of the disclosure can be modified, if necessary, to employ the systems, functions, and concepts of the above references and application to provide yet further embodiments of the disclosure. These and other changes can be made to the disclosure in light of the detailed description.

It will be appreciated that, although specific embodiments of the invention have been described herein for purposes of illustration, various modifications may be made without deviating from the spirit and scope of the invention. Accordingly, the invention is not limited except as by the claims.

1. A base comprising:
an anchoring component configured to secure a cartridge to the base;
a detection component comprising:
a window positioned to allow a light from a detection zone of the cartridge to enter the base when the cartridge is coupled to the base; and
a photodetector positioned to receive the light through the window and configured to generate a signal based on the light received from the window;
a plurality of light sources configured to emit one or more illumination lights onto the detection zone through the window when the cartridge is coupled to the base; and
a controller communicatively coupled to the photodetector and the plurality of light sources, the controller including logic that, when executed by the controller, causes the base to perform operations including:
illuminating the detection zone with the plurality of light sources; and
generating a detection signal with the photodetector based on the light received by the photodetector.

2. The base of claim 1, wherein the base further comprises an optical filter subcomponent positioned between the detection window and the photodetector to filter light received through the detection window.

3. The base of claim 1, wherein the base further comprises a docking port configured to receive the cartridge.

4. The base of claim 1, wherein the window defines a plane, and wherein the plurality of light sources are configured to emit the one or more illumination lights at a non-normal angle to the plane.

5. The base of claim 1, wherein the controller further includes logic that, when executed by the controller, causes the base to perform operations including:
generating a detection result based, at least in part, on the signal.

6. The base of claim 1, wherein the photodetector is configured to generate the signal based on an intensity of light received from the window.

7. The base of claim 6, wherein the photodetector is further configured to communicate the measured light intensity to the controller.

8. The base of claim 1, wherein the base is configured to connect to one or more other cartridges in addition to the cartridge.

9. The base of claim 8, wherein the base is configured to couple to one or more other bases.

10. The base of claim 1, wherein the controller is operatively coupled to the optical filter, the photodetector, and the plurality of light sources, the controller including logic that, when executed by the controller, causes the base to perform operations including:
positioning an optical filter of the optical filter component between the photodetector and the window;
analyzing the signal with the processor;
generating a detection result; and
outputting the detection result.

11. A system configured to analyze a sample, the system comprising:
a base comprising:
an anchoring component configured to secure the cartridge to the base;
a detection component comprising:
a window positioned to allow a light from a detection zone of the cartridge to enter the base when the cartridge is coupled to the base;
a photodetector, positioned to receive the light through the window and configured to generate a signal based on the light received from the window; and
an optical filter subcomponent positioned between the detection window and the photodetector to filter light received by the detection window;
a plurality of light sources configured to emit one or more illumination lights onto the detection zone through the window when the cartridge is coupled to the base; and
a controller communicatively coupled to the photodetector and the plurality of light sources of the controller including logic that, when executed by the controller, causes the base to preform operations, including:
illuminating the detection zone with the plurality of light sources; and
generating the detection signal with the photodetector based on the signal light received by the photodetector; and
a cartridge configured to hold a sample, comprising a transparent viewing field configured to be positioned in the detection zone when the cartridge is coupled to the base.

12. The system of claim 11, wherein the cartridge and the base are configured to form a light-tight seal when the cartridge is received by the base.

13. The system of claim 11, wherein the controller includes logic that, when executed by the controller, causes the system to perform operations including:
positioning an optical filter between the photodetector and the detection zone;
analyzing the signal;
generating a detection result; and
outputting the detection result.

14. The system of claim 13, wherein the cartridge further comprises an identifier indicative of an identity of the cartridge.

15. The system of claim 14, wherein the base further includes a contactless reader configured to generate an identity signal based on the identifier, wherein the contactless reader is operatively coupled to the controller, the controller including logic that, when executed by the controller, causes the base to perform operations based on the identity signal.

16. The system of claim 15, wherein the optical filter subcomponent comprises a plurality of optical filters disposed on a movable frame configured to allow different filters to be placed over the optical detection system.

17. The system of claim 16, wherein the identity signal generated is a filter identity signal, and wherein the controller includes logic that when executed by the controller, causes the base to position an optical filter of the plurality of optical filters in the detection zone based on the filter identity signal.

18. The system of claim 17, wherein the cartridge further comprises one or more pins configured to contact the movable filter frame.

19. The system of claim 18, wherein, when the one or more pins contact the movable frame, the moveable frame rotates to position an optical filter of the plurality of optical filters between the detection zone and the photodetector, and wherein the optical filter is configured to pass light of a first wavelength range.

20. The system of claim 19, wherein the system further comprises a second cartridge, wherein the second cartridge comprises two or more other pins positioned differently from the two or more pins, and wherein, when the two or more other pins contact the movable frame, a second optical filter of the plurality of optical filters is positioned between the detection zone and the photodetector, and wherein the second optical filter is configured to pass light of a second wavelength range, distinct from the first wavelength.

21. The system of claim 11 in which the photodetector is a camera, a flatbed scanner, or a laser scanner with a single detector.
